(19) United States
(12) Patent Application Publication
(10) Pub. No.: US 2006/0236810 A1
(43) Pub. Date: Oct. 26, 2006

(54) Bicycle pedal attaching device

(76) Inventors: Kuo Chih Chao, Taichung Hsien (TW); Chia Pin Chen, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/115,049

(22) Filed: Apr. 26, 2005

(51) Int. Cl. G05G 1/14

(52) U.S. Cl. 74/594.6

(57) ABSTRACT

A bicycle pedal attaching device includes a foot pedal having a front opening and an anchoring bar and a latch extended from the rear portion, and a coupler member having a front portion engaged into the front opening of the foot pedal and engaged with the anchoring bar of the foot pedal, and having a rear portion for being depressed and engaged with the rear latch of the foot pedal, to anchor and secure the coupler member to the foot pedal without rotating the coupler member relative to the foot pedal. The foot pedal includes a flange to engage with the coupler member. The coupler member includes an inclined surface or a swelling to facilitate an engaging of the coupler member with the foot pedal.

### BACKGROUND OF THE INVENTION

1. Field of the Invention

The present invention relates to a bicycle pedal attaching device, and more particularly to a bicycle pedal attaching device having a structure for allowing shoes to be easily and quickly attached to the bicycle pedals.

2. Description of the Prior Art

Typical bicycle pedal attaching devices comprise a coupling member attached to bottom of a shoe, such as a bicycle shoe, for attaching onto corresponding coupling member that is disposed or secured on the foot pedals of the bicycles, for securing or coupling the shoe to the foot pedals of the bicycles, and for preventing the shoe from being disengaged from the foot pedals of the bicycles inadvertently, particularly while riding the bicycles.

For example, U.S. Pat. No. 550,409 to Hanson discloses one of the typical bicycle pedal attaching devices comprising a bicycle foot pedal including foot bearing members for supporting the foot or the shoe of the user, a plate secured on top of the foot bearing members and having angular arms extended therefrom, for attaching or engaging into corresponding apertures or openings formed in the bottom of the shoe, and for allowing the shoe to be detachably attached or secured onto the foot pedals of the bicycles.

However, while attaching the shoe onto the foot pedals of the bicycles, the users have to precisely align with and engage the angular arms of the plate of the bicycle foot pedal into the apertures or openings of the shoe, and then have to rotate the shoe relative to the bicycle foot pedal, such that the users may not easily attach and may have to spend much more time to attach the shoe onto the foot pedals of the bicycles.

The present invention has arisen to mitigate and/or obviate the afore-described disadvantages of the conventional bicycle pedal attaching devices.

### SUMMARY OF THE INVENTION

The primary objective of the present invention is to provide a bicycle pedal attaching device including a structure for allowing the shoes to be easily and quickly attached to the bicycle pedals.

In accordance with one aspect of the invention, there is provided a bicycle pedal attaching device comprising a foot pedal including a front portion having an opening and an anchoring bar provided thereon, and including a rear portion having a latch extended therefrom, and a coupler member including a front portion for engaging into the front opening of the foot pedal, and for engaging with the anchoring bar of the foot pedal, in order to anchor and secure the front portion of the coupler member to the foot pedal, and including a rear portion for being depressed and engaged with the rear latch of the foot pedal, and for anchoring and securing the rear portion of the coupler member to the foot pedal without rotating the coupler member relative to the foot pedal.

The coupler member includes a protuberance extended upwardly from the rear portion thereof, to form a shoulder therein, and to stably receive and anchor the rear latch of the foot pedal, and to stably anchor and secure the rear portion of the coupler member to the foot pedal.

The coupler member includes a protrusion extended upwardly from the front portion thereof, to form a shoulder therein, and to receive and anchor the anchoring bar of the foot pedal, and to anchor and secure the front portion of the coupler member to the foot pedal.

The foot pedal includes a chamber formed therein and defined by an outer peripheral frame, and a tube attached in and across the chamber thereof, to separate the chamber thereof into the front opening and a rear opening.

The foot pedal includes a flange extended from top of the rear latch, and arranged to have a resilience to engage with the rear portion of the coupler member. The foot pedal includes a projection extended upwardly from a side portion thereof, to form a seat therein, and to support the coupler member.

The coupler member includes an inclined surface formed in bottom and front portion thereof, for facilitating an engagement of the front portion of the coupler member into the front opening of the foot pedal. Alternatively, the coupler member includes a swelling provided in a bottom portion thereof, and defined by at least one inclined surface, to facilitate an engagement of the front portion of the coupler member into the front opening of the foot pedal.

The coupler member includes a bulge extended upwardly from the rear portion thereof, for engaging with the rear latch of the foot pedal, and for reducing a contact area between the coupler member and the foot pedal.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a bicycle pedal attaching device in accordance with the present invention;

FIG. 2 is a perspective view of the bicycle pedal attaching device, illustrating the attachment of a shoe to a pedal of the bicycle pedal attaching device;

FIG. 3 is a perspective view of a coupler member of the bicycle pedal attaching device;

FIG. 4 is a partial cross sectional view of the bicycle pedal attaching device, taken along lines 4-4 of FIG. 2;

FIGS. 5, 6 are partial cross sectional views similar to FIG. 4, illustrating the operation of the bicycle pedal attaching device;

FIG. 7 is a perspective view similar to FIG. 2, illustrating the detaching or the disengagement of the coupler member from the pedal of the bicycle pedal attaching device;

FIG. 8 is a top plan view of the bicycle pedal attaching device as shown in FIG. 7;

FIGS. 9, 10, 11 are top plan views similar to FIG. 8, illustrating the other arrangements of the bicycle pedal attaching device;

FIGS. 12, 13, 14 are perspective views similar to FIG. 3, illustrating the further embodiments of the coupler member of the bicycle pedal attaching device;

FIG. 15 is an exploded view similar to FIG. 1, illustrating the embodiment of the bicycle pedal attaching device as shown in FIGS. 11 and 14;

FIG. 16 is an exploded view similar to FIGS. 1 and 15, illustrating the still further embodiment of the bicycle pedal attaching device; and

FIG. 17 is a perspective view similar to FIGS. 3 and 12-14, illustrating the still further embodiment of the bicycle pedal attaching device as shown in FIG. 16.

### DETAILED DESCRIPTION OF THE PREFERRED EMBODIMENT

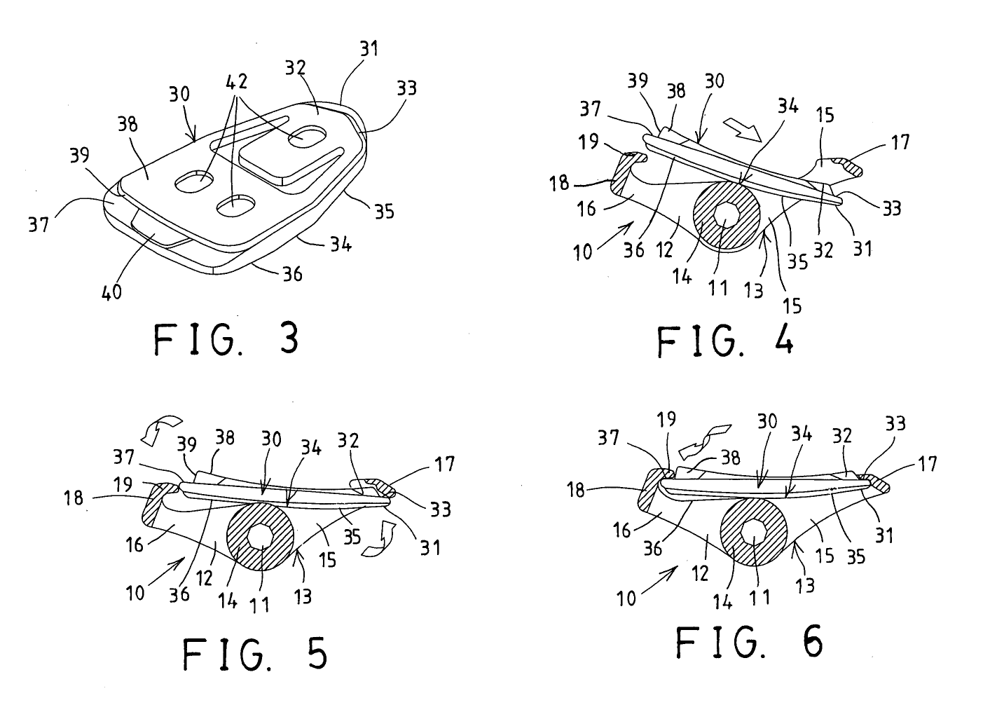

Referring to the drawings, and initially to FIGS. 1-4, a bicycle pedal attaching device in accordance with the present invention comprises a foot pedal 10 that may be attached with a shaft 11, to a cycle, such as a unicycle, a bicycle, a tricycle, a cycling exerciser, or the like. The foot pedal 10 includes a chamber 12 formed therein and defined by an outer peripheral frame 13, and a tube 14 formed or attached in or across the chamber 12 thereof, to separate the chamber 12 thereof into a front opening 15 and a rear opening 16, for example. The tube 14 may be provided for rotatably receiving and supporting the shaft 11.

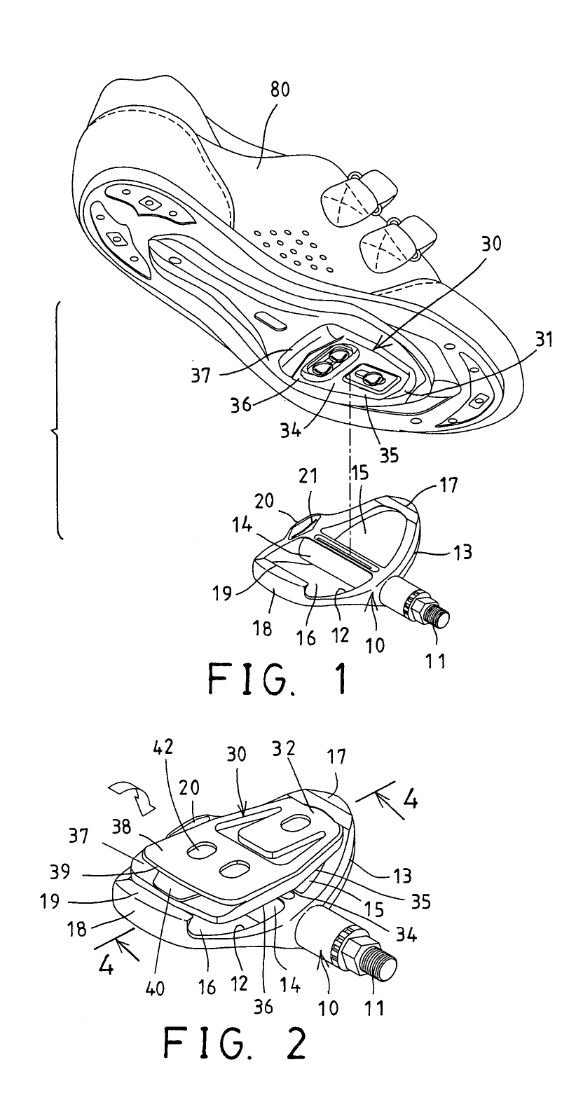

The outer peripheral frame 13 of the foot pedal 10 includes a front rounded or curved or inclined anchoring bar 17 provided thereon, and a latch 18 extended upwardly from the rear portion thereof and having a flange 19 extended forwardly from top of the rear latch 18, and arranged to allow the flange 19 and/or the rear latch 18 to include a suitable resilience or spring force or flexibility, and yet to have a predetermined or suitable stiffness, best shown in FIGS. 2 and 4-6. The foot pedal 10 further includes a projection 20 extended upwardly from a side portion thereof, to form a socket or a seat 21 therein.

A coupler member 30 includes a front portion 31 for engaging into the front opening 15 of the foot pedal 10, and for engaging with the anchoring bar 17 of the foot pedal 10 (FIGS. 4-6), for anchoring and securing the front portion 31 of the coupler member 30 to the foot pedal 10. It is preferable that the coupler member 30 includes a protrusion 32 extended upwardly from the front portion 31 thereof, to form a shoulder 33 therein, and to stably receive and seat and anchor the anchoring bar 17 of the foot pedal 10, and thus to further stably anchor or secure the front portion 31 of the coupler member 30 to the foot pedal 10.

It is preferable that the coupler member 30 further includes a swelling 34 formed or provided in the middle and bottom portion thereof, and defined by one or more inclined surfaces 35, 36 that may be formed in the front and the rear portions and the bottom portion thereof, best shown in FIG. 4-6, to facilitate the engagement of the front portion 31 of the coupler member 30 into the front opening 15 of the foot pedal 10 (FIG. 4), and then for engagement with the anchoring bar 17 of the foot pedal 10 (FIGS. 5-6), and to form a resilient coupling between the front portion 31 of the coupler member 30 and the anchoring bar 17 of the foot pedal 10.

The coupler member 30 further includes a rear portion 37 for being moved or engaged over the flange 19 or the rear latch 18 of the foot pedal 10, and for engaging with the rear latch 18 of the foot pedal 10 (FIGS. 4-6), for anchoring and securing the rear portion 37 of the coupler member 30 to the foot pedal 10. It is preferable that the coupler member 30 includes a protuberance 38 extended upwardly from the rear portion 37 thereof, to form a shoulder 39 therein, and to stably receive and seat and anchor the rear latch 18 of the foot pedal 10, and thus to further stably anchor or secure the rear portion 37 of the coupler member 30 to the foot pedal 10.

As shown in FIGS. 2, 3, 7 and 11, the coupler member 30 may further include a bulge 40 extended upwardly from the rear portion 37 thereof, and offset or spaced away from the protuberance 38 thereof, for engaging with the flange 19 or the rear latch 18 of the foot pedal 10, and for reducing the contact area between the coupler member 30 and the foot pedal 10. Alternatively, the coupler member 30 may include no bulge extended therefrom (FIGS. 9, 12), or may include a depression 41 formed therein (FIGS. 10, 13), also for reducing the contact area between the coupler member 30 and the foot pedal 10.

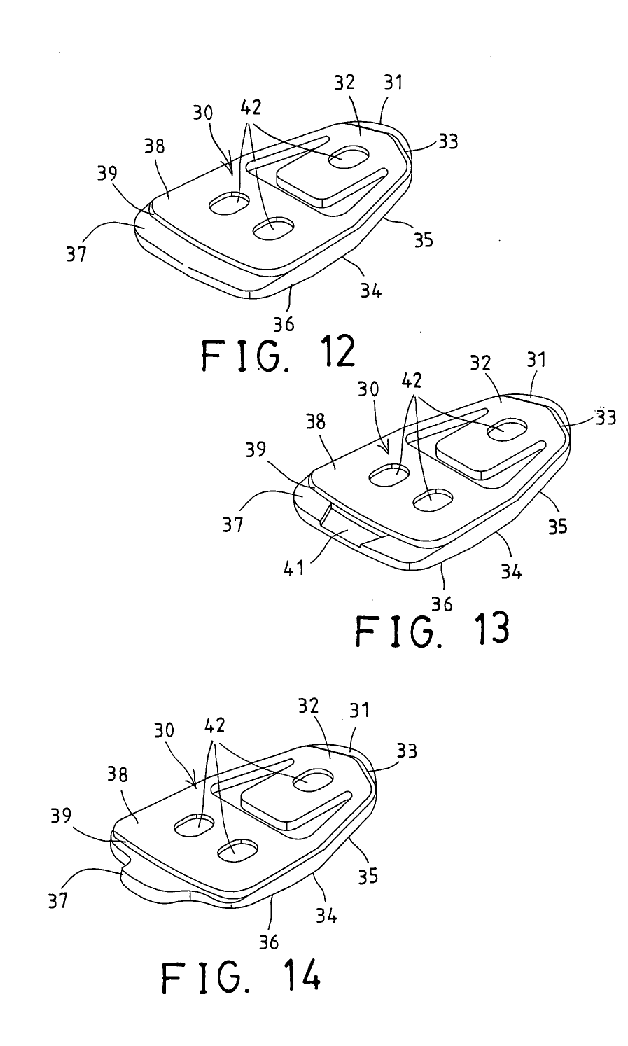

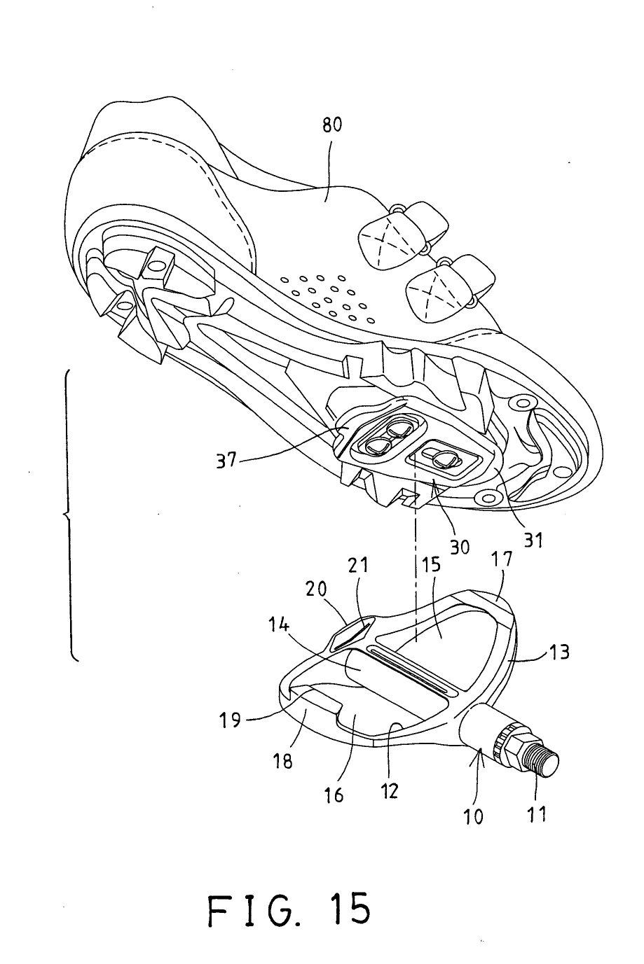

Further alternatively, the flange 19 and/or the rear latch 18 of the foot pedal 10 may include a shorter or decreased width or length, as shown in FIGS. 11 and 14-15, also for reducing the contact area between the coupler member 30 and the foot pedal 10. The coupler member 30 may include one or more orifices 42 formed therein, for receiving such as fasteners (not shown), which may be used to secure or to attach the coupler member 30 to the bottom of a shoe 80, such as a shoe 80 for road cycling purposes (FIG. 1), or a shoe 80 for mountain cycling purposes (FIG. 15), to allow the shoes 80 to be attached or coupled to the foot pedal 10.

In operation, as shown in FIGS. 2 and 4-6, the rider or the wearer of the shoe 80 may first engage the front portion 31 of the coupler member 30 into the front opening 15- of the foot pedal 10, and then with the anchoring bar 17 of the foot pedal 10, to anchor and secure the front portion 31 of the coupler member 30 to the foot pedal 10, and then may depress or force the rear portion 37 thereof to engage over the flange 19 or the rear latch 18 of the foot pedal 10, and then to engage with the rear latch 18 of the foot pedal 10, and thus to anchor and secure the rear portion 37 of the coupler member 30 to the foot pedal 10, best shown in FIG. 6.

It is to be noted that the rider or the wearer of the shoe 80 may thus easily force and engage or anchor or couple the shoe 80 onto the foot pedal 10 by directly depressing the coupler member 30 onto the foot pedal 10, without rotating the coupler member 30 relative to the foot pedal 10, such that the shoe 80 may be easily and quickly attached or coupled to the foot pedal 10 by simply and directly stepping the shoe 80 onto the foot pedal 10. The side portion of the coupler member 30 may be received and seated and supported in the seat 21 of the foot pedal 10, and by the projection 20 of the foot pedal 10.

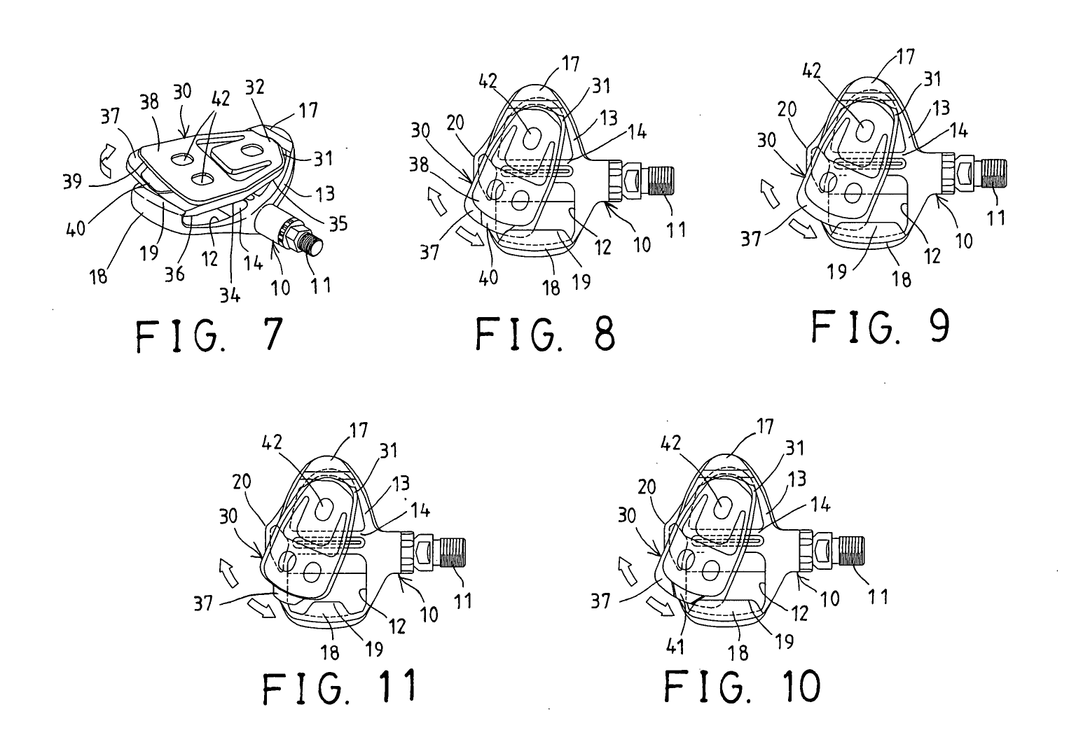

When it is required to remove the coupler member 30 from the foot pedal 10, as shown in FIGS. 7-11, it is only required to rotate the rear portion 37 of the coupler member 30 relative to the foot pedal 10, and against the projection 20 of the foot pedal 10, to offset or to disengage the rear portion 37 of the coupler member 30 from the flange 19 or the rear latch 18 of the foot pedal 10, and thus to allow the coupler member 30 and the shoe 80 to be disengaged from the foot pedal 10. It is preferable that the projection 20 of the foot pedal 10 includes an inclination for allowing the coupler member 30 to move over the projection 20 of the foot pedal 10.

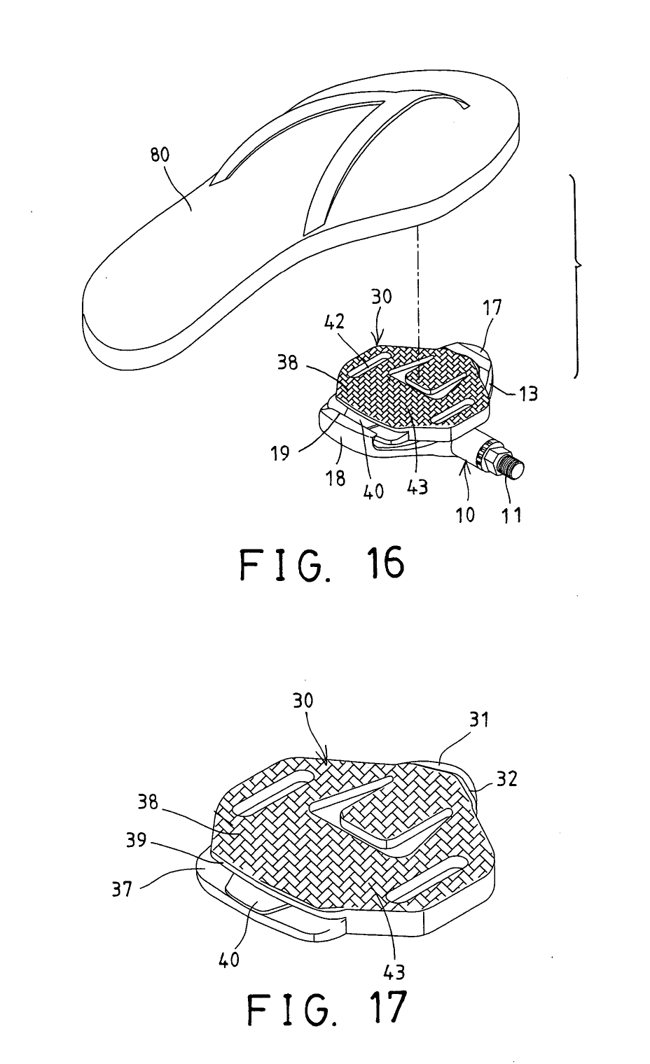

Alternatively, as shown in FIGS. 16 and 17, the coupler member 30 may be directly attached or secured onto the foot pedal 10, and may further include a rough or serrated surface 43 formed or provided on the upper portion thereof, for frictionally engaging with a sandal or a shoe 80 that is provided for walking purposes (FIG. 16), and thus for allowing the riders to wear the shoes 80 other than those for road cycling or for mountain cycling purposes, and to ride the cycles without securing or attaching the coupler member 30 to the shoes 80, such that the bicycle pedal attaching device may be used for attaching various shoes 80 to the foot pedal 10.

Accordingly, the bicycle pedal attaching device in accordance with the present invention includes a structure for allowing the shoes to be easily and quickly attached to the bicycle pedals.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A bicycle pedal attaching device comprising:
a foot pedal including a front portion having an opening and an anchoring bar provided thereon, and including a rear portion having a latch extended therefrom, and
a coupler member including a front portion for engaging into said front opening of said foot pedal, and for engaging with said anchoring bar of said foot pedal, in order to anchor and secure said front portion of said coupler member to said foot pedal, and including a rear portion for being depressed and engaged with said rear latch of said foot pedal, and for anchoring and securing said rear portion of said coupler member to said foot pedal without rotating said coupler member relative to said foot pedal.

2. The bicycle pedal attaching device as claimed in claim 1, wherein said coupler member includes a protuberance extended upwardly from said rear portion thereof, to form a shoulder therein, and to stably receive and anchor said rear latch of said foot pedal, and to stably anchor and secure said rear portion of said coupler member to said foot pedal.

3. The bicycle pedal attaching device as claimed in claim 1, wherein said coupler member includes a protrusion extended upwardly from said front portion thereof, to form a shoulder therein, and to receive and anchor said anchoring bar of said foot pedal, and to anchor and secure said front portion of said coupler member to said foot pedal.

4. The bicycle pedal attaching device as claimed in claim 1, wherein said foot pedal includes a chamber formed therein and defined by an outer peripheral frame, and a tube attached in and across said chamber thereof, to separate said chamber thereof into said front opening and a rear opening.

5. The bicycle pedal attaching device as claimed in claim 1, wherein said foot pedal includes a flange extended from top of said rear latch, and arranged to have a resilience to engage with said rear portion of said coupler member.

6. The bicycle pedal attaching device as claimed in claim 1, wherein said foot pedal includes a projection extended upwardly from a side portion thereof, to form a seat therein, and to support said coupler member.

7. The bicycle pedal attaching device as claimed in claim 1, wherein said coupler member includes an inclined surface formed in bottom and front portion thereof, for facilitating an engagement of said front portion of said coupler member into said front opening of said foot pedal.

8. The bicycle pedal attaching device as claimed in claim 1, wherein said coupler member includes a swelling provided in a bottom portion thereof, and defined by at least one inclined surface, to facilitate an engagement of said front portion of said coupler member into said front opening of said foot pedal.

9. The bicycle pedal attaching device as claimed in claim 1, wherein said coupler member includes a bulge extended upwardly from said rear portion thereof, for engaging with said rear latch of said foot pedal, and for reducing a contact area between said coupler member and said foot pedal.
